(19) United States
(12) Patent Application Publication
(10) Pub. No.: US 2021/0014380 A1
(43) Pub. Date: Jan. 14, 2021

(54) IMAGE PROCESSING DEVICE, IMAGE FORMATION SYSTEM, IMAGE PROCESSING METHOD, AND IMAGE PROCESSING PROGRAM

(71) Applicant: KONICA MINOLTA, INC., Tokyo (JP)

(72) Inventor: Kazuhiko IMANISHI, Tokyo (JP)

(73) Assignee: KONICA MINOLTA, INC., Tokyo (JP)

(21) Appl. No.: 16/911,548

(22) Filed: Jun. 25, 2020

(30) Foreign Application Priority Data
Jul. 11, 2019 (JP) 2019-129369

(51) Int. Cl. H04N 1/387; G06F 3/12; H04N 1/00

(52) U.S. Cl. CPC H04N 1/387; H04N 1/00037; G06F 3/1296

(57) ABSTRACT

The present invention provides an image processing device capable of correcting an image formation position page by page. The image processing device has: an obtaining unit obtaining a print job corresponding to a plurality of pages; a determination unit obtaining a read image of a sheet in which an image is formed for at least two pages in the plurality of pages and determining a deviation amount in the at least two pages; a calculation unit calculating at least two correction values on the basis of the deviation amount in the at least two pages; and a correction unit performing image correction on each of the plurality of pages on the basis of a corresponding correction value in the at least two correction values.

### CROSS-REFERENCE TO RELATED APPLICATIONS

The entire disclosure of Japanese Patent Application No. 2019-129369, filed on Jul. 11, 2019, is incorporated herein by reference in its entirety.

### BACKGROUND

### Technological Field

The present invention relates to an image processing device, an image formation system, an image processing method, and an image processing program.

There is an image forming device having a post-process device for performing cutting, folding, or the like to a sheet-shaped recording medium subjected to image formation. To such an image forming device, a technique to be described hereinafter is proposed for preventing occurrence of a position deviation and density variation in parts which are originally apart from each other but come adjacent by the folding of recording media subjected to image formation.

First, regions which come adjacent to each other after a post process are found out on the basis of sheet information and post-process information of a job and set as setting regions. Subsequently, a position in which a register mark is printed is determined in the regions which come adjacent after the prost process, and a chart for adjustment in which the register mark is printed is output. After printing, the chart for adjustment is read by an image reading unit, the register mark position is measured from the read chart for adjustment, a correction value is calculated and applied to control of an image formation unit, and the job is output (refer to patent literature 1).

### Citation List

### Patent Literature

Patent literature 1: Japanese Unexamined Patent Application Publication No. 2018-189728

### SUMMARY

In image formation using ink or toner, the shrinkage ratio of a recording medium after image formation varies depending on the coverage. Consequently, in variable printing of forming images which are different among pages, the formation position of an image on a recording medium varies depending on the coverage of the image formed on the recording medium.

However, in the conventional art as described above, one correction value is calculated on the basis of reading of a chart for adjustment at the time of outputting a job, and the calculated one correction value is applied to the control of the image formation unit. Therefore, in the case of applying the above-described technique to, for example, execution of the variable printing in which the coverage varies among pages, image formation in which the formation position is corrected page by page cannot be executed, and a problem occurs such that, for example, a recording medium cannot be cut in a predetermined state in a post process based on the formation position of a register mark.

Therefore, an object of the present invention is to provide an image processing device, an image formation system, an image processing method, and an image processing program capable of correcting an image formation position page by page.

To achieve such an object, according to an aspect of the present invention, an image processing device reflecting one aspect of the present invention has: an obtaining unit obtaining a print job corresponding to a plurality of pages: a determination unit obtaining a read image of a sheet in which an image is formed for at least two pages in the plurality of pages and determining a deviation amount related to the at least two pages; a calculation unit calculating at least two correction values on the basis of the deviation amount related to the at least two pages; and a correction unit performing image correction on each of the plurality of pages on the basis of a corresponding correction value in the at least two correction values.

### BRIEF DESCRIPTION OF THE DRAWINGS

The advantages and features provided by embodiments of the invention will become more fully understood from the detailed description given hereinbelow and the appended drawings which are given by way of illustration only, and thus are not intended as a definition of limits of the present invention:

FIG. 1 is a schematic diagram illustrating a general configuration of an image formation system having an image processing device according to embodiments of the present invention;

FIG. 2 is a block diagram of the image formation system according to the embodiments of the invention;

FIG. 3 is a functional configuration diagram of a control unit in the image formation system according to the embodiments of the invention;

FIG. 4 is a flowchart illustrating an image processing method according to a first embodiment of the invention;

FIG. 5 is a diagram illustrating an example of a setting screen of a position correcting method which is displayed in the image processing method according to the first embodiment of the invention;

FIG. 6 is a diagram illustrating storage of correction values in the first embodiment of the invention;

FIG. 7 is a diagram illustrating an example of a manual correction screen which is displayed in the image processing method according to the first embodiment of the invention;

FIG. 8 is a flowchart illustrating procedure of execution of a print job in the image processing method according to the first embodiment of the invention;

FIG. 9 is a flowchart illustrating an image processing method according to a second embodiment of the invention;

FIG. 10 is a diagram illustrating an example of a setting screen of a position correcting method which is displayed in the image processing method according to the second embodiment of the invention;

FIG. 11 is a diagram illustrating an example of a test print page designation screen which is displayed in the image processing method according to the second embodiment of the invention;

FIG. 12 is a diagram illustrating a designation example (No. 1) of a test print page in the second embodiment of the invention;

FIG. 13 is a diagram illustrating a designation example (No. 2) of the test print page in the second embodiment of the invention;

FIG. 14 is a diagram illustrating a designation example (No. 3) of the test print page in the second embodiment of the invention;

FIG. 15 is a diagram illustrating a storage example (No. 1) of correction values in the second embodiment of the invention;

FIG. 16 is a diagram illustrating a storage example (No. 2) of correction values in the second embodiment of the invention; and

FIG. 17 is a diagram illustrating a storage example (No. 3) of correction values in the second embodiment of the invention.

### DETAILED DESCRIPTION OF EMBODIMENTS

Hereinafter, embodiments to which the present invention is applied will be described in detail with reference to the drawings. However, the scope of the invention is not limited to the embodiments. The same reference numerals are designated to components which are common in the embodiments and a part of repetitive explanation will be omitted.

### Schematic Configuration of Image Forming Device in Embodiments

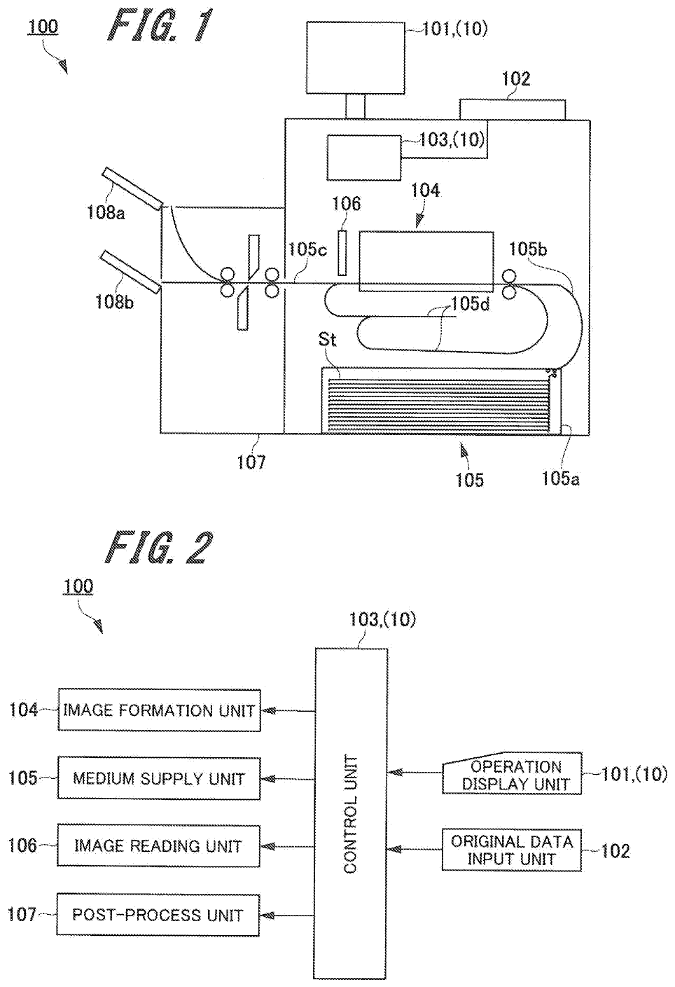

FIG. 1 is a schematic diagram illustrating a general configuration of an image formation system 100 having an image processing device according to an embodiment of the present invention. FIG. 2 is a block diagram of the image formation system according to the embodiment of the invention. The image formation system 100 illustrated in FIGS. 1 and 2 is a system for forming an image of a sheet St as a recording medium and has a configuration including an image processing device 10 for forming an image in a predetermined position on the sheet St. The image formation system 100 may further has a function of performing a post process such as cutting or folding to the sheet St on which an image is formed and outputting the resultant sheet. Such an image formation system 100 has an operation display unit 101, an original data input unit 102, a control unit 103, an image formation unit 104, a medium supply unit 105, an image reading unit 106, and a post-process unit 107. The configuration of each of the members is as follows.

### Operation Display Unit 101

The operation display unit 101 is a part of inputting a setting of a print job and a setting of an image process executed by using the image formation system 100 and has a display panel and an operation button. The operation button may be a touch panel provided integral with a display panel. Settings of jobs are the size of the sheet St, the number of images intensively formed on one sheet St, one-side printing or duplex printing, the number of print copies, and the like. Settings of the image process are, as will be specifically described later in the image processing method, correction of the formation position of an image on the sheet St and the like.

The operation display unit 101 is a component of the image processing device 10 in the image formation system 100. The operation display unit 101 may be a personal computer or another external device connected to the image formation system 100. In the case where the image processing device 10 is connected as another member in the image formation system 100, the image processing device 10 has an operation display unit for inputting a setting of the image process.

### Original Data Input Unit 102

The original data input unit 102 has an original stand and a reading device of reading an image in an original which is placed on the original stand. The original data input unit 102 may input, for example, original data of an image received from the personal computer or another external device connected to the image formation system 100 or may be an input/output interface.

### Control Unit 103

The control unit 103 controls operations of the units in the image formation system 100 in accordance with an operation in the operation display unit 101 or a reception signal from the external device such as the personal computer connected to the image formation system 100 and is configured by a computing machine. The computing machine is hardware used as a so-called computer. The computing machine has a CPU (Central Processing Unit), a ROM (Read Only Memory), and a RAM (Random Access Memory) and also has a nonvolatile storage and a network interface.

The control unit 103 executes a characteristic control which will be described later in the image processing method and a part of the function is a component of the image processing device 10 in the image formation system 100. The procedure of the processes executed by the control unit 103 is loaded and stored, as an image processing program and an image forming program of controlling operations of the units of the image formation system 100, from the ROM or the external device to the RAM or a nonvolatile storage.

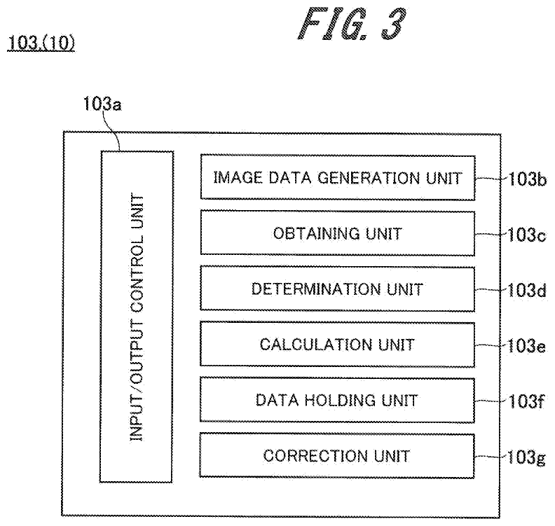

FIG. 3 is a functional configuration diagram of the control unit 103 in the image formation system according to the embodiment of the invention. As illustrated in the diagram, the control unit 103 has an input/output control unit 103a, an image data generation unit 103b, an obtaining unit 103c, a determination unit 103d, a calculation unit 103e, a data holding unit 103f, and a correction unit 103g. Hereinafter, the configuration of each of the units will be described with reference to FIGS. 1 to 3.

### Input/Output Control Unit 103a

The input/output control unit 103a is connected to the units constructing the image formation system 100 such as the operation display unit 101, the original data input unit 102, the image formation unit 104, the medium supply unit 105, the image reading unit 106, and the post-process unit 107. The input/output control unit 103acontrols the driving of the image formation unit 104, the medium supply unit 105, the image reading unit 106, and the post-process unit 107 on the basis of inputs from the operation display unit 101, the original data input unit 102, and the external device and, further, the image formation program and the image process program stored in the control unit 103. The control of the driving of the units by the input/output control unit 103a will be described in detail later in the image processing method.

### Image Data Generation Unit 103b

The image data generation unit 103b generates image data for printing by performing msterizing process on original data of an image formed on the sheet St by execution of a print job. The image data generation unit 103b may be, for example, a raster image processor (RIP). The original data of the image processed by the image data generation unit 103b may be an image input from the original data input unit 102 which is, for example, an image input from the external device via a network interface or, in the case where the original data input unit 102 has a reading device, original data read from the reading device.

The image data generation unit 103b generates image data obtained by imposing and laying out an image of image data generated on the basis of original data to the surface and the back face of the sheet St as a recording medium on the basis of the setting of the print job input from the operation display unit 101 or the external device. Further, the image data generation unit 103b adds a mark for recognizing the formation position of the image on the sheet St to the image data. Such a mark is, for example, a cross-shaped register-mark image formed at four corners of a maximum print region in the sheet St.

### Obtaining Unit 103c

The obtaining unit 103c obtains a print job corresponding to a plurality of pages. It is assumed that the print job is, for example, input from the operation display unit 101 or the external device and held in the data holding unit 103f or stored in the external device. It is assumed here that a page is one of main surfaces of one sheet St. Consequently, also in the case of intensively forming a plurality of images on one of the main surfaces of one sheet St, it is assumed that one of the main surfaces of one sheet St on which the plurality of images are formed is one page.

### Determination Unit 103d

The determination unit 103d determines a position deviation amount from a set position, of the formation position of an image formed on the sheet St. The determination of the position deviation amount in the determination unit 103d is performed on the basis of a read image which is read from the sheet St on which the image is formed. The determination unit 103d determines a position deviation amount from at least two pages designated in the image processing method to be described later, in a plurality of pages on which a print job is executed.

Reading of an image from the sheet St on which the image is formed is not limited to execution by the image reading unit 106 as an inline sensor provided on the inside of the image formation system 100 but an external image reading device such as a nearline sensor or an offline sensor may be used.

### Calculation Unit 103e

The calculation unit 103e calculates a correction value of the formation position of the image formed on the sheet St on the basis of the position deviation amount determined by the determination unit 103d. The correction value may be a number obtained by inverting the direction of the position deviation amount. Such a calculation unit 103e calculates at least two correction values on the basis of the position deviation amount determined by the determination unit 103d as will be described later in the image processing method.

### Data Holding Unit 103f

The data holding unit 103f holds a control program for the CPU as a component of the control unit 103 to control the units of the image formation system 100 and original data of an image input from the original data input unit 102. The data holding unit 103f stores information related to a print job input from the operation display unit 101 and the external device and image data for printing which is generated by the image data generation unit 103b.

Particularly, the data holding unit 103f stores a correction value calculated by the calculation unit 103e every corresponding page. In the case of forming an image on both sides of one sheet St, a correction value is associated with each of both sides of one sheet St and stored.

### Correction Unit 103g

The correction unit 103g performs image correction for correcting the formation position of an image to the sheet St on the basis of the correction value calculated by the calculation unit 103e for each of a plurality of pages on which a print job is executed. Such a correction unit 103g performs the image correction on the basis of a corresponding correction value out of at least two correction values calculated by the calculation unit for each of a plurality of pages on which a print job is executed.

### Image Formation Unit 104

Referring again to FIG. 1, the image formation unit 104 is a part for forming an image by printing on the main surface of the sheet St as a recording medium in accordance with an instruction from the control unit 103. The image forming method of the image formation unit 104 is not limited and, for example, an electrophotography type or an ink jet type is applied. As an example, the image formation unit 104 of the electrophotography type has a toner image formation unit, an intermediate transfer belt, a fixing unit, and the like and a toner image is formed on one main surface of the sheet St. The image formation unit 104 of the ink jet type has an ink jet head and an ink image is formed on one main surface of the sheet St.

### Medium Supply Unit 105

The medium supply unit 105 is a part of sequentially supplying the sheet St to the image formation unit 104 and the post-process unit 107 in accordance with an instruction from the control unit 103. Such a medium supply unit 105 has a medium housing unit 105a housing a large amount of sheets St and a medium supply path 105b supplying the sheets St housed in the medium housing unit 105a one by one to the image formation unit 104. The medium supply unit 105 has a medium discharging and carrying path 105c carrying the sheet St on which an image is printed by the image formation unit 104 to the following post-process unit 107.

The medium supply unit 105 further has a medium inverting and carrying path 105d for inverting the sheet St on which the image is printed by the image formation unit 104 upside down with respect to the carrying direction and supplying the sheet St again to the image formation unit 104. With the configuration, in the image formation unit 104, an image can be printed on two main faces which are the surface and the back face of the sheet St.

### Image Reading Unit 106

The image reading unit 106 may be, for example, a general inline sensor made by a CCD and a CMOS sensor and reads an image formed on the sheet St by the image formation unit 104 and discharged from the image formation unit 104. The image reading unit 106 is not limited to an inline sensor which is provided on the inside of the image formation system 100. An external image reading device such as a nearline sensor or an offline sensor may be used.

### Post-Process Unit 107

The post-process unit 107 performs a post process such as cutting or folding to the sheet St carried from the image formation unit 104 in accordance with an instruction from the control unit 103. Cutting of the sheet St in the post-process unit 107 is executed using a register mark image formed on the sheet St as a mark The sheet St subjected to the post process is sequentially discharged to trays 108a and 108b.

### Image Processing Method of First Embodiment

Next, a first embodiment of the image processing method executed by the image formation system 100 having the units as described above will be described. The image processing method to be described hereinafter is realized by executing processes based on the image process program stored in a ROM or RAM by the CPU of each of the function units constructing the control unit 103 also as the image processing device 10.

### Setting of Correction Value of Image Formation Position

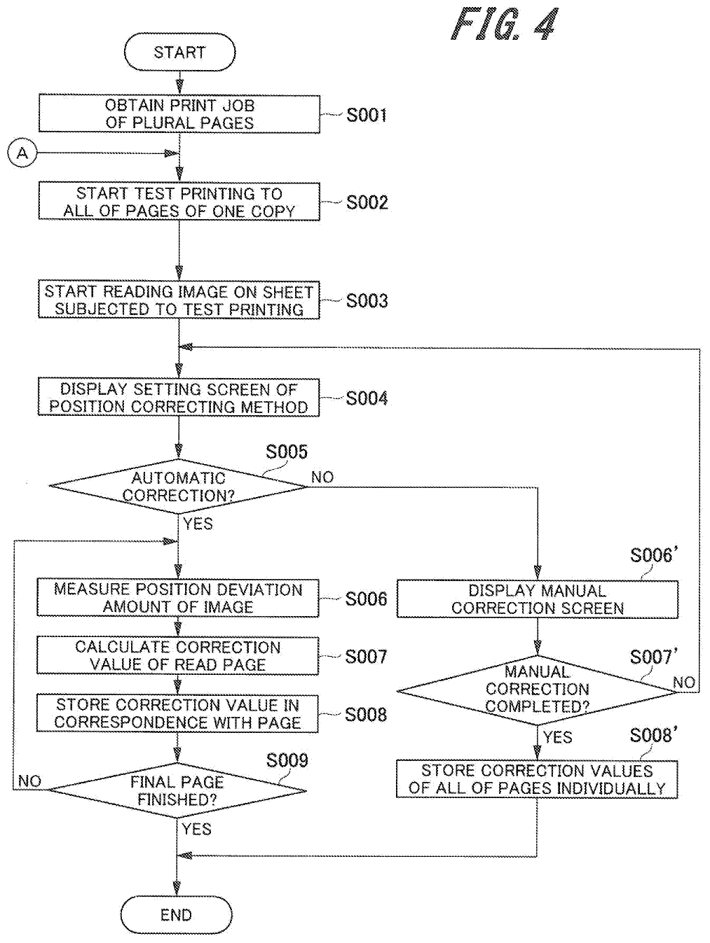

FIG. 4 is a flowchart illustrating an image processing method according to the first embodiment of the invention, and is a diagram illustrating the procedure of setting a correction value of an image formation position. Hereinafter, the procedure of setting a correction value of an image formation position in the image processing method of the first embodiment of the invention will be described in the order of the flowchart illustrated in FIG. 4 with reference to the above-described FIGS. 1 to 3. The flow starts when a print job is input from the operation display unit 101 or the external device, or starts when an input of starting an image process is performed in the operation display unit 101.

### Step S001

In step S001, the obtaining unit 103c obtains a print job of a plurality of pages as an object of an image process. A print job as an object of an image process may be, as an example, data of a print job which is input from the operation display unit 101 or an external device and held in the data holding unit 103f or data which is input from an external device.

The print job obtained here is the number of print copies, the number of images intensively printed on one sheet St, selection of one-side printing or duplex printing, setting of a post process, and the like. The print job may include image data formed on each page. It is assumed that the image data is data generated by the image data generation unit 103b.

As a print job, it is assumed that, as an example, a setting of printing two images intensively on one of the faces of one sheet St which is one page, cutting the one sheet St which is one page to two sheets as a post process, and cutting the periphery of the sheet St is stored.

After this step S001 and before the next step S002, a step in which the operator of the image formation system 100 can select whether position correction is executed or not may be performed and, in the case of selecting execution of position correction, the program may advance to the next step S002.

### Step S002

In step S002, the input/output control unit 103a starts test printing based on the setting of the job for all of pages of the print job obtained. The input/output control unit 103a prints an image including a register-mark image in a setting position in each sheet St on the basis of the image data for printing generated by the image data generation unit 103b.

### Step S003

In step S003, the input/output control unit 103a instructs the image reading unit 106 to read the image on the sheet St subjected to the test printing. In response to it, the image reading unit 106 starts sequentially reading the images in the entire region in the sheets St on which the images are formed by the image formation unit 104.

### Step S004

In step S004, the input/output control unit 103a instructs the operation display unit 101 to display the setting screen of the position correcting method. In response to it, the operation display unit 101 displays the setting screen of the position correcting method. FIG. 5 is a diagram illustrating an example of a setting screen [S1] of a position correcting method which is displayed in the image processing method according to the first embodiment of the invention. As illustrated in the diagram, as the setting screen [S1] of the position correcting method, a selection screen for making the operator of the image formation system 100 select either “automatic calculation of correction value” or “manual correction” is displayed.

### Step S005

In step S005, the input/output control unit 103a determines whether automatic correction is performed or not as the position correcting method. In the case where “automatic calculation of correction value” is selected from the options displayed in the operation display unit 101 in step S004, the input/output control unit 103adetermines “execution of automatic correction (YES)” and the program advances to step S006. On the other hand, in the case where “manual correction” is selected, “no execution of automatic correction (NO)” is determined, and the program advances to step S006′. The case of advancing to step S006 will be described first.

### Step S006

In step S006, the determination unit 103d obtains the read image which is read by the image reading unit 106 and, on the basis of the obtained read image, determines a position deviation amount of the image formed on the sheet St with respect to the page on which the read image is formed. The position deviation amount is a value measured as a position deviation amount from the set position and, as an example, an amount of deviation from the set position, of the formation position of the register mark image for the periphery part of the sheet St.

### Step S007

In step S007, the calculation unit 103e calculates a correction value of the print position of the image on the page from which the image is read, from the position deviation amount measured in step S006. The correction value may be the number obtained by inverting the direction of the position deviation amount.

### Step S008

In step S008, the data holding unit 103f stores the correction value calculated in step S007 in association with the page from which the image is read.

### Step S009

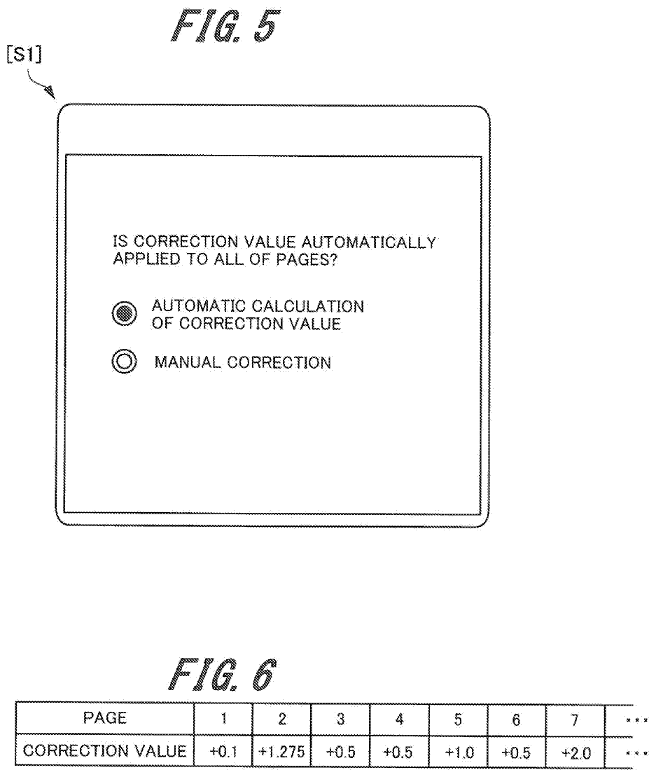

In step S009, the input/output control unit 103a determines whether the process is finished to the final page or not and, until “finished (YES)” is determined, repeats the process from step S006. By the operation, the correction value is stored so as to be associated with the page with respect to all of the pages to which the test printing is performed. FIG. 6 is a diagram illustrating storage of correction values in the first embodiment of the invention. As illustrated in the diagram, in the data holding unit 103f, the correction value calculated in step S007 is stored so as to be associated with each of the pages as one sheet St.

### Step S006′

On the other hand, in step S006′ advanced by the determination of “no automatic correction (NO)” in step S005, the input/output control unit 103a instructs the operation display unit 101 to display the manual correction screen. By the instruction, the operation display unit 101 displays a screen for manually correcting the print position.

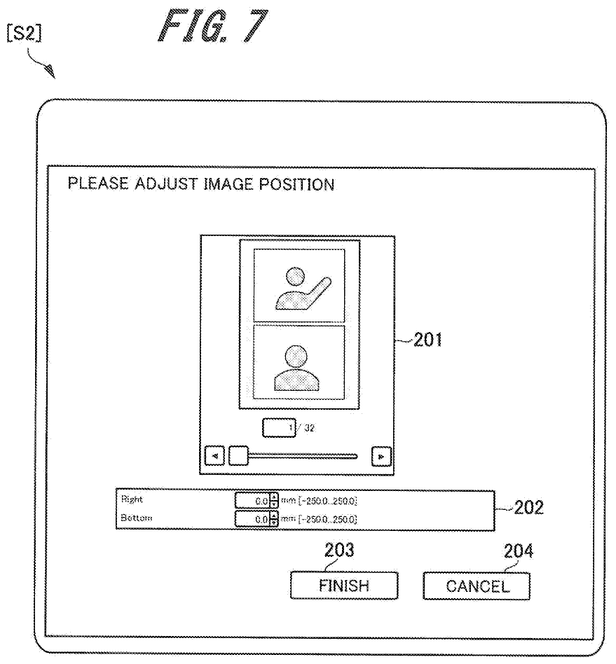

FIG. 7 is a diagram illustrating an example of a manual correction screen [S2] which is displayed in the image processing method according to the first embodiment of the invention. As illustrated in FIG. 7, the manual correction screen [S2] displays a read image screen 201 displaying the image read in step S003, a print position adjustment part 202 for adjusting the print position of the image on the sheet St, a manual correction finish button 203, and a manual correction cancel button 204.

The operator sequentially selects read images of pages to be subject to position correction in the read image screen 201 displayed in the manual correction screen [S2] and adjusts the print position of the image in the selected read image in the print position adjustment part 202. The read image screen 201 is displayed by moving the image to the position adjusted in the print position adjustment part 202. In such a manner, the operator can adjust the print position while checking the image. The operator operates the finish button 203 in the case where the manual correction is completed and, operates the cancel button 204 in the case of cancelling the manual correction.

### Step S007′

In step S007′, the input/output control unit 103a determines whether the manual correction is finished or not. In the case where the finish button 203 is operated in the manual correction screen [S2], the input/output control unit 103a determines that the manual correction is completed (YES) and advances to step S008′. On the other hand, in the case where the cancel button 204 is operated in the manual correction screen [S2], the input/output control unit 103a determines that the manual correction is not completed (NO) and the manual correction is cancelled, and returns to step S004.

### Step S008′

In step S008′, the data holding unit 103f stores the correction value adjusted in step S006′ so as to be associated with the page. The correction value for a page which is not selected in the manual correction screen [S2] is set to zero (0). As illustrated in FIG. 6 described above, the correction value adjusted on the basis of display in step S006′ is stored in association with each page as one sheet St in the data holding unit 103f.

In the above-described series of procedure, after step S009, an image of each page to which the correction value stored in the data holding unit 103f is applied may be displayed in the operation display unit 101. Consequently, the operator can recognize an image to which a correction value is applied. In this case, an automatic correction finish button and an automatic correction cancel button are displayed together with an image of each page and a step of determining whether the automatic correction may be finished or not is provided. A configuration may also be employed that, in the case where the cancel button is operated, the program returns to step S005 and, based on an image to which a correction value obtained by automatic correction is applied, manual correction is further executed.

### Execution of Print Job

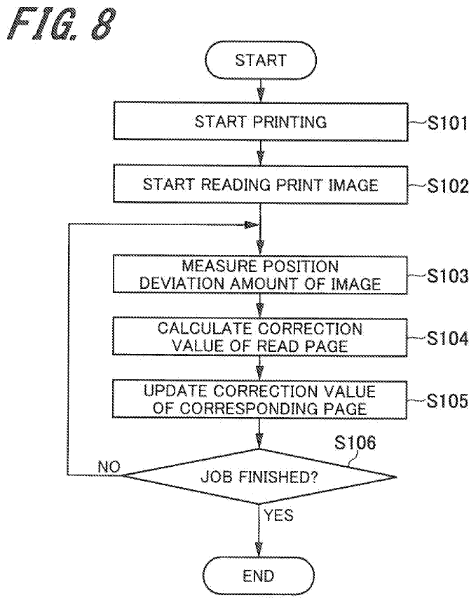

FIG. 8 is a flowchart illustrating procedure of execution of a print job in the image processing method according to the first embodiment of the invention. Hereinafter, in order of the flowchart of FIG. 8, referring to FIGS. 1 to 3, the procedure of execution of a print job will be described. After the procedure described using the flowchart of FIG. 4 is finished, the following flow is automatically started or started by a predetermined input from the operation display unit 101 or an external device.

### Step S101

In step S101, the input/output control unit 103a starts printing of an image to the sheet St by driving of the image formation unit 104 and the medium supply unit 105. The correction unit 103g refers to a correction value of each of pages stored in the data holding unit 103f and performs image correction on the image data generated by the image data generation unit 103b. The input/output control unit 103a prints an image in a corrected position in the sheet St by the driving of the image formation unit 104 and the medium supply unit 105.

### Step S102

In step S102, the input/output control unit 103a instructs the image reading unit 106 to read the image of the sheet St printed. By the instruction, the image reading unit 106 starts reading images sequentially in the entire region of the sheets St on which the image is formed by printing in the image formation unit 104.

### Step S103

In step S103, the determination unit 103d measures the position deviation amount of an image formed on the sheet St with respect to a page from which the image is read on the basis of read image data which is read by the image reading unit 106. The position deviation amount is measured as a position deviation amount from a setting position and is, for example, an amount of deviation from the setting position, of the formation position of a register mark image at a periphery part of the sheet St.

### Step S104

In step S104, the calculation unit 103e calculates a correction value of the print position of the image on the page from which the image is read, from the position deviation amount measured in step S103.

### Step S105

In step S105, the data holding unit 103f updates the correction value stored in the data holding unit 103f in association with the page from which the image is read to the correction value calculated in step S104. When the job executed by the flow is a job of printing a plurality of copies, for printing of the next copy after the correction value is updated, the correction unit 103g performs image correction to which the updated correction value is applied and prints and forms an image in the image-corrected position.

### Step S106

In step S106, the input/output control unit 103a performs determination of whether the job is finished or not and, when it is determined that the job is not finished (NO), returns to step S103, and repeats the following steps.

### Effects of First Embodiment

According to the first embodiment described above, at the time of executing a print job of a plurality of pages, by making a correction value individually correspond to each of the plurality of pages, the formation position of an image can be corrected page by page in any of the case of forming the same image in the plurality of pages and the case of forming different images in the plurality of pages. Consequently, particularly, in variable printing of forming different images in a plurality of pages, even in the case where the deviation amount of the formation position of an image varies because images are different, image formation in which the position deviation is corrected in accordance with the position deviation amount of each page can be executed.

Further, by feeding back the position deviation amount obtained by reading from a sheet on which an image is formed by a print job, the more the number of print copies increases in one print job, the more the precision of the formation position of an image can be increased.

### Image Processing Method of Second Embodiment

Next, a second embodiment of an image processing method executed by the above-described image formation system 100 will be described. The image processing method to be described hereinafter is realized when the CPU of each of function units constructing the control unit 103 also as the image processing device 10 executes a process based on an image processing program stored in a ROM or RAM.

### Setting of Correction Value of Image Formation Position

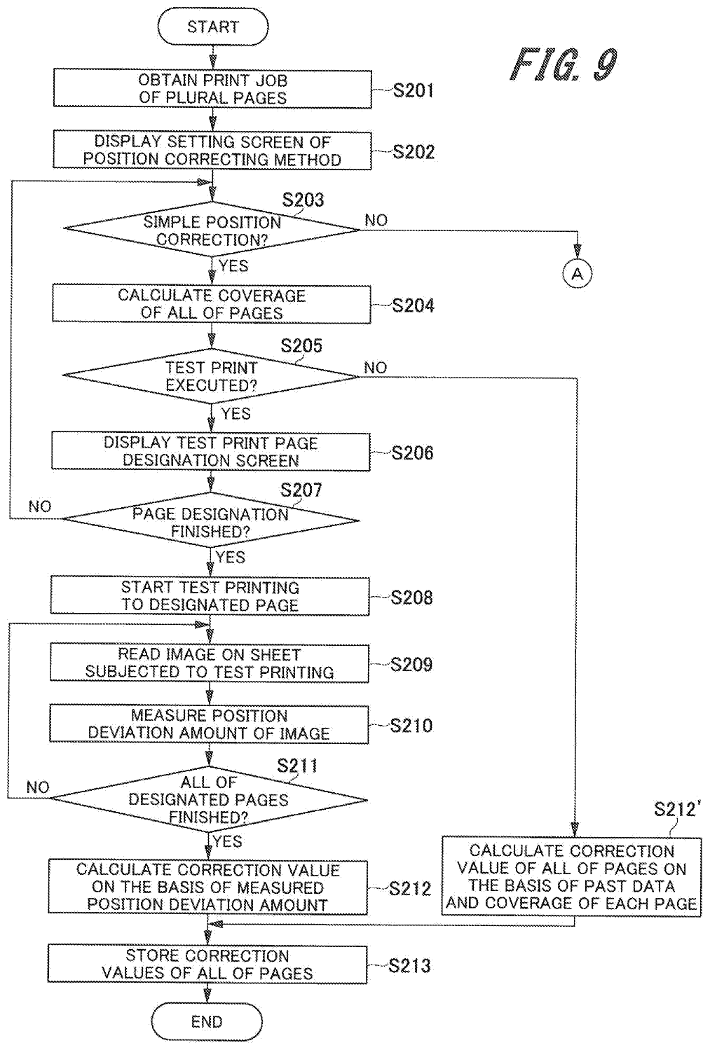

FIG. 9 is a flowchart illustrating an image processing method according to the second embodiment of the invention and is a diagram illustrating a procedure of setting a correction value of an image formation position. Hereinafter, in order of the flowchart of FIG. 9, referring to FIGS. 1 to 3, the procedure of setting a correction value of an image formation position in the image processing method of the second embodiment of the invention will be described. The following flow is started when a print job is input from the operation display unit 101 or an external device or started when an input of starting an image process is made in the operation display unit 101.

### Step S201

In step S201, the obtaining unit 103c obtains a print job of a plurality of pages as an object of the image process. The print job as an object of the image process is, as an example, data of a print job which is input from the operation display unit 101 or an external device and held in the data holding unit 103f or data which is input from an external device like the first embodiment.

A configuration may be employed such that after step S201 and before the next step S202, a step which can be selected by the operator of the image formation system 100 of determining whether position correction is executed or not is executed and, when execution of position correction is selected, the program advances to the next step S202.

### Step S202

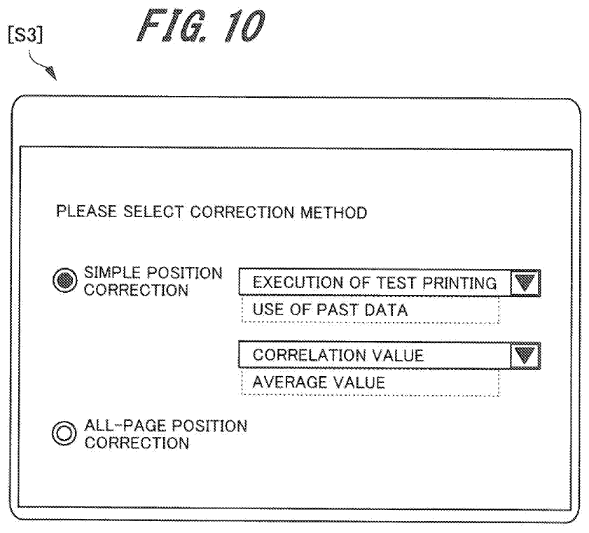

In step S202, the input/output control unit 103a instructs the operation display unit 101 to display the setting screen of the position correcting method. In response to it, the operation display unit 101 displays the setting screen of the position correcting method. FIG. 10 is a diagram illustrating an example of a setting screen [S3] of the display correcting method which is displayed in the image processing method according to the second embodiment of the invention. As illustrated in the diagram, as the setting screen [S3] of the position correcting method, a selection screen for making the operator of the image formation system 100 select either “simple position correction” or “all-page position correction” is displayed. As the setting screen [S3] of the position correcting method, when the simple position correction is selected, a selection screen for making the operator of the image formation system 100 select either “execution of test printing” or “use of past data” is displayed.

Further, in the setting screen [S3] of the position correcting method, when “simple position correction” is selected, a selection screen for making the operator of the image formation system 100 select either calculation of “correlation value” or calculation of “average value” as the correction value calculating method is displayed.

### Step S203

In step S203, the input/output control unit 103a executes determination of whether “simple position correction” is selected or not in the options displayed in the setting screen [S3] of the position correcting method in step S202. When it is determined that “simple position correction” is selected (YES), the program advances to step S204.

On the other hand, when “all-page position correction” is selected in the options displayed in the setting screen [S3] of the position correcting method in step S202, the input/output control unit 103a determines that “simple position correction” is not selected (NO). The program advances to step S002 in the flowchart of FIG. 4 in the first embodiment, and the following steps are executed.

### Step S204

In step S204, the input/output control unit 103a calculates coverage with respect to all of the pages of the obtained print job. In this case, the input/output control unit 103a calculates the coverage of an image of each page on the basis of the image data for printing generated by the image data generation unit 103b. The input/output control unit 103a stores the calculated coverage in association with the page in the data holding unit 103f.

### Step S205

In step S205, the input/output control unit 103a makes determination of whether a test print is executed or not. In the case where “simple position correction” is selected in the setting screen [S3] of the position correcting method in step S202 and, further, in the case “execution of test print” is selected, the input/output control unit 103a determines to execute a test print (YES) and advances to step S206.

On the other hand, in the case where “simple position correction” is selected in the setting screen [S3] of the position correcting method in step S202 and, further, in the case “use of past data” is selected, the input/output control unit 103a determines not to execute a test print (NO) and advances to step S212′.

### Step S206

In step S206, the input/output control unit 103a instructs the operation display unit 101 to display a test print page designation screen. In response to it, the operation display unit 101 displays a screen for designating a page to be subjected to test printing.

FIG. 11 is a diagram illustrating an example of a test print page designation screen [S4] which is displayed in the image processing method according to the second embodiment of the invention. As illustrated in the diagram, in the test print page designation screen [S4], an image data screen 401, a designation method setting screen 402, a designation finish button 403, and a designation cancel button 404 are displayed.

In the image data screen 401, an image based on image data of all of pages generated by the image data generation unit 103b is displayed. The image is an image to which a register mark image is added. In the case where manual designation is selected in the designation method setting screen 402 which will be described later, the image data screen 401 displays so that an image in each page can be designated.

In the designation method setting screen 402, any of “manual designation”, “designation by page”, and “designation by coverage” can be selected.

In the case where “manual designation” is selected, the designation method setting screen 402 may additionally display coverage of an image in each page as a reference of designation of a test print page.

In the designation method setting screen 402, in the case where “designation by page” is selected, either “manual setting” or “step setting” can be selected and, further, a set value can be input. “Step setting” is a setting of designating pages which are set at predetermined intervals such as, for example, every five pages or 10 pages.

In the designation method setting screen 402, in the case where “designate by coverage” is selected, any of “manual setting”, “step setting”, “automatic selection (high)”, “automatic selection (low)”, and “automatic selection (balance)” can be selected. “Step setting” is a setting of designating a page by setting the coverage at predetermined intervals such as, for example, every 10% or every 20%. In the case where “manual setting” or “step setting” is selected, a set value can also be input.

“Automatic selection (high)” is a setting of automatically designating a page in which the coverage is rather high among the coverages of the pages calculated in step S204 (for example, pages corresponding to tens % from the highest coverage). “Automatic selection (low)” is a setting of automatically designating a page in which the coverage is rather low among the coverages of the pages calculated in step S204 (for example, pages corresponding to tens % from the lowest coverage). “Automatic selection (balance)” is a setting of automatically designating a predetermined number of pages in accordance with a distribution of the coverages of the pages calculated in step S204.

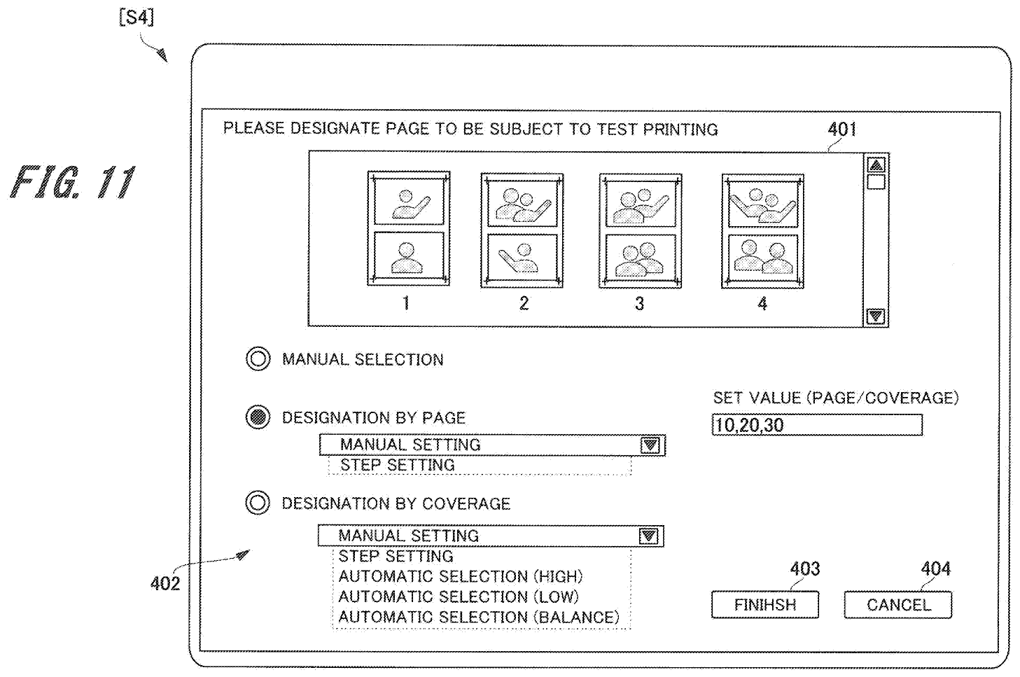

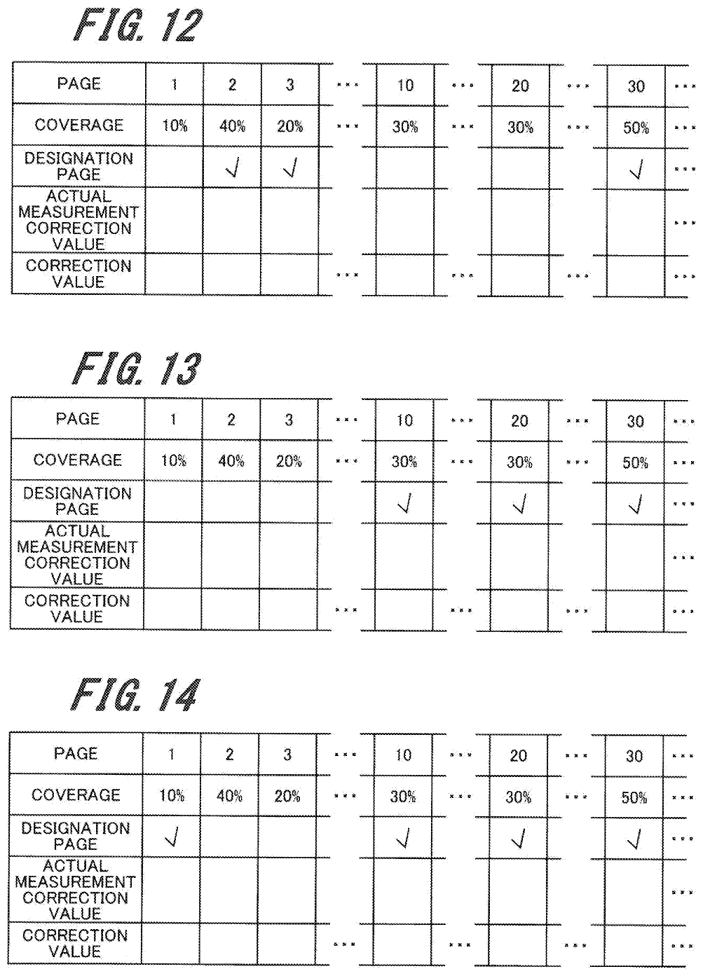

FIGS. 12 to 14 are diagrams illustrating designation examples (No. 1) to (No. 3) of a test print page in the second embodiment of the invention. As indicated by check marks in FIGS. 12 to 14, a page designated in the test print page designation screen [S4] is extracted as a designation page and held in the data holding unit 103f. For example, FIG. 12 illustrates the case where “manual designation” is selected in the designation method setting screen 402 and a test print page is manually designated. FIG. 13 illustrates the case where “step setting” in “designation by page” is selected in the designation method setting screen 402 and a step of every 10 pages is entered as a set value. Further, FIG. 14 illustrates the case where “manual setting” in “designation by coverage” is selected in the designation method setting screen 402 and 10, 30, and 50% are entered as setting values.

The designation (extraction) of a page to which test printing is performed is not limited to the above but a proper designation method may be used as an option.

### Step S207

In step S207, the input/output control unit 103a determines whether the page designation is completed or not. In the case where the finish button 403 is operated in the test print page designation screen [S4], the input/output control unit 103a determines that the page designation has been completed (YES) and advances to step S208. On the other hand, in the case where the cancel button 404 is operated in the test print page designation screen [S4], the input/output control unit 103a determines that the page designation has not been completed (NO), determines that the page designation of test print is cancelled, and returns to step S203.

### Step S208

In step S208, the input/output control unit 103a starts the test printing of the page designated in the test print page designation screen [S4]. The input/output control unit 103a prints an image including a register mark image in a set position in each sheet St on the basis of the image data for printing generated by the image data generation unit 103b.

### Step S209

In step S209, the input/output control unit 103a instructs the image reading unit 106 to read the image on the sheet St subjected to the test printing. In response to it, the image reading unit 106 starts reading the image in the entire region of the sheet St sequentially in the sheets St on which images are formed by the image formation unit 104.

### Step S210

In step S210, the determination unit 103d obtains a read image which is read by the image reading unit 106 and, on the basis of the obtained read image, determines the position deviation amount of the image formed on the sheet St with respect to the page on which this read image is formed. The position deviation amount is a value measured as a position deviation amount from the setting position and is, for example, an amount of deviation of the formation position of a register mark image in the peripheral part of the sheet St from the setting position.

### Step S211

In step S211, the input/output control unit 103a determines whether measurement of a position deviation amount has been finished or not on all of pages designated in the test print page designation screen [S4] displayed in step S206. In the case where it is determined that the measurement is finished (YES), the program advances to step S212. In the case where it is determined that the measurement has not been finished (NO), the program returns to step S210.

### Step S212

In step S212, the calculation unit 103e calculates correction values of all of pages on the basis of the coverage of a designation page and a position deviation amount. In this case, according to the calculating method which is set in the setting screen [S3] of the position correcting method (refer to FIG. 10) in step S202, a correction value is calculated. That is, in the case where “correlation value” is selected in the setting screen [S3], the correlation between the coverage of each page in which the position deviation amount is measured in step S210 and the position deviation amount is derived, and the correction values (correlation correction values) of all of the pages are calculated on the basis of the derived correlation. In the case where “average value” is selected in the setting screen [S3], an average value of the position deviation amounts of the pages measured in step S210 is obtained, and a correction value (average correction value) is calculated from the average value.

### Step S213

In step S213, the data holding unit 103f stores the calculated correction value in association with a page. At this time, with respect to the designation page, the correction value calculated on the basis of the measured position deviation amount may be stored as it is. Consequently, the most accurate correction value is stored in association with the designation page.

FIG. 15 is a diagram illustrating a storage example (No. 1) of correction values in the second embodiment of the invention, which is an example of the case where “correlation value” is selected in the setting screen [S3] of the position correcting method (refer to FIG. 10) in step S202. With respect to the designation page, the correction value calculated on the basis of the measured position deviation amount is stored as it is, and the correlation correction value is stored in association with a page other than the designation page.

It is assumed that the data holding unit 103f accumulates the relation between the correction value (correlation correction value) calculated as described above and the coverage or the relation between the position deviation amount and the coverage.

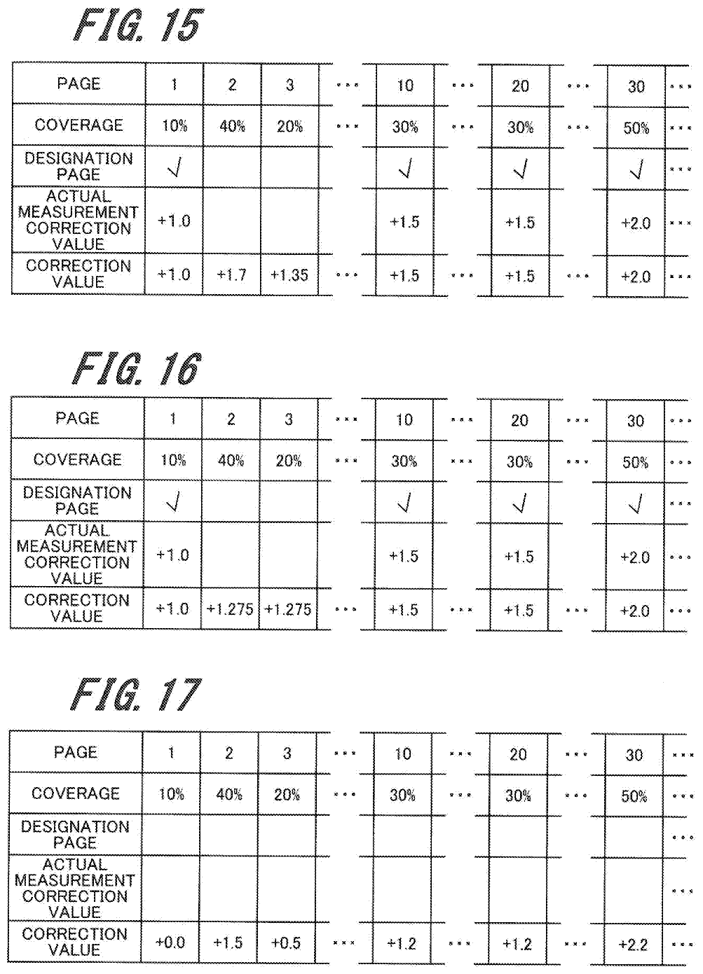

FIG. 16 is a diagram illustrating a storage example (No. 2) of correction values in the second embodiment of the invention, which is an example of the case where “average value” is selected in the setting screen [S3] of the position correcting method (refer to FIG. 10) in step S202. With respect to a designation page, a correction value calculated on the basis of the measured position deviation amount is stored as it is, and an average correction value is stored in association with a page other than the designation page.

### Step S212′

On the other hand, in step S212′ advanced by the determination of not executing test printing (NO) in step S205, the input/output control unit 103a calculates correction values of all of pages on the basis of past data stored in the data holding unit 103f and the coverages of all of the pages calculated in step S204. After that, the program advances to step S213. The correlation between the coverage and the position deviation amount or the correction value is obtained from the past data and, on the basis of the correlation and the coverages of all of the pages calculated in step S204, correction values of all of the pages are calculated.

FIG. 17 is a diagram illustrating a storage example (No. 3) of correction values in the second embodiment of the invention. As illustrated in the diagram, in the data holding unit 103f, the coverage of each page calculated in step S204 and the correction value of each page calculated on the basis of data between the past coverage and the position deviation amount of an image are stored in association with each page.

In the above-described procedure of steps S201 to S213, the coverages of all of pages are calculated in step S204. However, the invention is not limited to the calculation of coverages of all of pages. For example, a flow that, after step S203, the program advances to step S206 without executing step S204 of calculating the coverage may also be employed. After executing steps S206 to S211, in place of step S212, an average value of measured position deviation amounts may be calculated and one correction value may be calculated from the average value. Also in this case, the calculated one correction value is held in association with each page. To the page in which a position deviation amount is calculated in step S210, a correction value based on the calculated position deviation amount is applied and held.

### Execution Method of Print Job

The print job obtained in step S201 after setting the correction value of the image formation position for each page as described above is executed by the procedure described in the first embodiment in accordance with the flowchart described by using FIG. 8 in the first embodiment. In this case, the correction value updated in association with the page from which the image is read in step S105 may be applied to image formation in a different page in which an image will be formed later and with which the same coverage is associated. The correction value, however, is not applied to a page in which the position deviation amount is measured. In a manner similar to the first embodiment, an updated correction value may be applied to a copy after the correction value is updated.

### Effects of Second Embodiment

According to the second embodiment described above, at the time of executing a print job of a plurality of pages, by making a correction value individually correspond to each of the plurality of pages, effects similar to those of the first embodiment can be obtained. Since image formation in which a position deviation of an image is corrected can be performed on the basis of a result of image formation in the past including test printing, it is unnecessary to perform test printing on all of pages.

Although the embodiments of the present invention have been described and illustrated above, the disclosed embodiments are made for purposes of illustration and example only and not limitation. The scope of the present invention should be interpreted by the terms of the appended claims

### DESCRIPTION OF REFERENCE NUMERALS

1 . . . image formation system
10 . . . image processing device
103c . . . obtaining unit
103d . . . determination unit
103e . . . calculation unit
103g . . . correction unit
104 . . . image formation unit
St . . . sheet

What is claimed is:

1. An image processing device comprising:
an obtaining unit obtaining a print job corresponding to a plurality of pages:
a determination unit obtaining a read image of a sheet on which an image is formed for at least two pages in the plurality of pages and determining a deviation amount in the at least two pages;
a calculation unit calculating at least two correction values on the basis of the deviation amount in the at least two pages; and
a correction unit performing image correction on each of the plurality of pages on the basis of a corresponding correction value in the at least two correction values.

2. The image processing device according to claim 1, wherein the at least two pages are all of the plurality of pages, and the image correction is performed to each of the plurality of pages on the basis of all of read images of the plurality of pages.

3. The image processing device according to claim 1, wherein the at least two pages are pages extracted at predetermined intervals from the plurality of pages, and image correction is performed to each of the plurality of pages on the basis of read images of the pages extracted at the predetermined intervals.

4. The image processing device according to claim 1, wherein the at least two pages are pages extracted from the plurality of pages on the basis of coverage, and image correction is performed to each of the plurality of pages on the basis of read images of the pages extracted on the basis of the coverage.

5. The image processing device according to claim 4, wherein the calculation unit calculates the correction value for each of the plurality of pages on the basis of correlation between the coverage and the deviation amount of the at least two pages.

6. The image processing device according to claim 5, wherein a correction value which is calculated directly from the deviation amount is applied as the correction value related to the at least two pages to which determination of the deviation amount is performed.

7. The image processing device according to claim 5, wherein the calculation unit calculates a correction value which corresponds to each of the plurality of pages on the basis of the correlation and the coverage for each of the plurality of pages.

8. An image formation system comprising:
the image processing device according to claim 1; and
an image formation unit forming an image on a sheet on the basis of correction in the correction unit.

9. The image formation system according to claim 8, wherein a read image on a sheet on which an image is formed by the image formation unit on the basis of correction in the correction unit is fed back to the image processing device.

10. An image processing method comprising:
obtaining a print job corresponding to a plurality of pages;
obtaining a read image of a sheet in which an image is formed for at least two pages in the plurality of pages and determining a deviation amount in the at least two pages;
calculating at least two correction values on the basis of the deviation amount in the at least two pages; and
performing image correction on each of the plurality of pages on the basis of a corresponding correction value in the at least two correction values.

11. A non-transitory computer readable recording medium storing an image processing program making a computer to perform:
obtaining a print job corresponding to a plurality of pages;
obtaining a read image of a sheet in which an image is formed for at least two pages in the plurality of pages and determine a deviation amount in the at least two pages;
calculating at least two correction values on the basis of the deviation amount in the at least two pages; and
performing image correction on each of the plurality of pages on the basis of a corresponding correction value in the at least two correction values.
